(19) United States
(12) Patent Application Publication
(10) Pub. No.: US 2003/0233318 A1
(43) Pub. Date: Dec. 18, 2003

(54) Systems and methods for fund transfers

(76) Inventors: Douglas W. King, Santa Maria, CA (US); David J. Liu, Santa Barbara, CA (US)

Correspondence Address: WINSTON & STRAWN, PATENT DEPARTMENT, 1400 L STREET, N.W., WASHINGTON, DC, 20005-3502, US

(21) Appl. No.: 10/304,394

(22) Filed: Nov. 26, 2002

Related U.S. Application Data
(60) Provisional application No. 60/333,641, filed on Nov. 26, 2001.

(51) Int. Cl. G06F 17/60

(52) U.S. Cl. 705/39

(57) ABSTRACT

A system and method permits the transfer of funds between a transferor account and a transferee account through interaction with a transfer execution system. Money may be transferred from one account to another account in a different financial institution, which may occur for example in real time or without substantial delay in completing the process. The accounts that are to be used in the transfer may be identified based on the communications addresses of the users communicating with the system. A transfer code may be provided which in some embodiments may be used to identify one or more of the accounts to be used for the transfer when the transfer code is submitted to the system by one of the participants of the transfer. To implement desired transfers, the system may communicate with a financial network which may provide communications with the financial institutions of the users.

### CROSS-REFERENCE TO RELATED PATENT APPLICATIONS

This application claims the benefit of U.S. Provisional Patent Application No. 60/333,641, filed Nov. 26, 2001, which is hereby incorporated by reference herein in its entirety.

### FIELD OF THE INVENTION

The present invention relates to the field of money transfer between accounts. More particularly, the present invention relates to a method and system for the transfer of money from one account to another securely and instantly without exchanging account data between the parties to the transfer.

### DESCRIPTION OF THE PRIOR ART

As the financial needs of the general population evolves, there is a demand to improve the way money may be transferred from one person to another. The traditional method of transferring cash provides a minimal transfer of information between the parties involved, yet is not practical in many ways. Cash can be easily lost or stolen, at which time it may be difficult to find or replace. Using cash on a regular basis also leads to an exhaustion of the physical cash supply of a transferor, which in turn requires repeated trips to a bank or other cash source to replenish the supply.

On the receiving side, a large number of cash receipts leads to an accumulation of physical cash. Such an accumulation must be protected from theft and deposited into a bank account at regular intervals.

While money transfers by check alleviate some of the problems of using cash, it creates other problems. A check is generally not guaranteed unless the transferor goes the length of giving a bank check or a money order. This is not a practical solution for many situations, particularly those involving a large volume of money transfers. It is also often expensive to purchase bank checks or money orders.

Checks also provide the payee, as well as any subsequent endorsers, information regarding the account on which the check is drawn. For example, the bank name and account number are normally printed on a check. A transferor may not want a transferee and others to have this additional information. Moreover, checks often contain other information, such as name, address and telephone number. In many instances, the tendering of a check elicits a demand for a driver's license or other identification information. Clearly, the use of checks includes many serious drawbacks.

Transfer of money between two different accounts generally requires that the transferor have the account data of the transferee so that the transfer can be effected. For example, funds may be transferred by wiring funds into a receiving account, either from the sender's account or by a service that accepts cash or other payment and then sends the funds to a recipient (such as Western Union®). It also normally requires that the sender have knowledge of the receiver's account number, so as to enable the transfer. This raises security issues since the transferor would gain access to confidential information of the transferee (e.g., the transferee's account number) which the transferee may not want to disclose. More seriously, with access to confidential information of the transferor, such as the transferor's account number, the unscrupulous transferee can attempt to withdraw money from the transferor's account without permission from the transferor.

Another drawback of money transfers between accounts in prior art methods is that the transfer is generally not instantaneous. Rather, time is needed for the transfer to clear which will depend on the particular banks involved. This can be problematic if, for example, immediate, nearly immediate, or instantaneous transfer is needed.

None of these methods in the known prior art result in a real time or quick credit to a receiving account. Neither would the sender's account be debited in real time. These methods thus may entail inconvenient delays. For example, the transfer of cash between two accounts requires that the transferor first go to a bank or other source of cash, withdraw funds from their account, go to the transferee's location, transfer the cash and optionally receive change. The transferee collects the cash, optionally pays out change, goes to their bank or place of deposit, and deposits the cash into their account. Each of these steps involves a potential delay.

Some known existing systems provide automated telephone or computer based opportunities to consumers for intra-institution transfer of funds between accounts. However, one drawback of such systems again is that the transferor is typically required to know personal information regarding the transferee to conduct a transfer.

Some existing systems provide financial services without requiring users to provide their confidential information. However, such systems have thus far been deficient in providing cash transfers, real-time cash transfers, transfers between bank checking or savings accounts, etc.

Accordingly, there is a need to provide a method of and system for transferring money between two accounts which overcome problems with the prior art. It is another object of the present invention to provide a method of and system for transferring money between two accounts wherein account data of the parties is not shared between the parties. It is yet another object of the present invention to provide a method of and system for transferring money between two accounts wherein the transfer is instantaneous or nearly instantaneous. Other objects of the present invention will become apparent from the following discussion.

### SUMMARY OF THE INVENTION

The purpose and advantages of the present invention will be set forth in and apparent from the description that follows, as well as will be learned by practice of the embodiments illustratively describe d herein. Additional advantages will be realized and attained by the methods and systems particularly pointed out in the written description and claims hereof, as well as from the appended drawings.

To achieve these and other advantages and in accordance with the principles of the present invention, as embodied and described herein, methods and systems for sending funds from a sender's account to a receiver's account are provided.

Funds transfer such as money transfers may be quickly, conveniently, and, if desired, anonymously completed using transfer codes. If desired, a central database of account related information and associated communications address information may be implemented in connection with providing transfer codes. In some embodiments, users may register with a system to gain access to the transfer features.

Information regarding user communications addresses and account information such as a debit/ATM card number, an account number, a financial institution routing number, etc. may be obtained and stored in a database for future use. Such information may be obtained through a registration process or through user input when a transfer is desired. Information associating a financial account with a communication address may be used by the system to identify a financial account to be used in a transfer.

A transfer system for providing such transfer features or services may support one or more communications platforms or protocols through which registered users may interact with the system. For example, the transfer system may be capable of communicating with users via landline telephone, cellular telephones, text messaging, e-mail messaging, instant messaging, etc. to submit account number and amount of transfer. If desired, a user may register addresses that are used by that user in one or more platforms or protocols, so that the user does not have to enter full account information for each transaction. For example, in some embodiments the system may provide users with the option o register to have their information available for future transfers or to enter their account information for a transaction (e.g., for each particular transaction).

The transfer system or an associated system may be capable of identifying (e.g., detecting) the current communications address form which a user is communicating with the transfer system. The identification of the addresses may serve to identify and authenticate the current user when the communications addresses are matched with a known address for one of the system users. For example, an address that is stored in a database which is accessible by or included as part of the transfer system. Further user protection and security may be provided by storing personal identification codes of users and prompting user entry of personal identification codes when users contact the system. Therefore, if desired, the transfer system may be implemented to include one or more of the following: registration of users who are transferees, registration of users who are transferors, association of account information with communications address information of transferees, association of account information with communications address information of transferors, user input of account information when a transferor indicates that he or she is to send funds, user input of account information when a transferee indicates that he or she is to receive funds, or automatic association of user information such as a communications address with an account based on prior communications or transfers. Other techniques may also be implemented.

The transfer system may have a communications link to a network supporting financial activity between financial institutions. The network may include a financial communications network that supports automated teller machines for completing ATM transactions. The financial communications network may be primarily dedicated to financial activity.

A transfer code may be assigned when a user indicates to the system that the user is to receive funds. The transfer code may be provided to the user to allow the user to provide the transfer code to intended user(s) who will be sending funds. The system may also allow the user who will be receiving funds to identify an address to which the code should be sent in order to provide the code to the appropriate individuals. The system may identify account information for the receiver of the funds from a database of information by identifying which communications address (e.g., which registered communications address) was used to indicate that the receiver is to receive funds. The system may associate the transfer code with the account information of the receiver. If desired, the transfer code may serve (e.g., may only serve) as an identifier for a desired transaction.

A sender of the funds may contact the system and submit the code to the system. The system may identify the sender's account information by comparing the sender's current communications address with communications addresses for which the system has associated account information. As mentioned herein, other techniques for identifying account information may also be used. The sender may be required to enter a personal identification code to provide an additional level of security for transfers. Once the sender's and receiver's account information is known, the transfer system may take steps to complete the transfer. For example, using an ATM network, the system may debit the sender's account and credit the receiver's account with an appropriate amount which was identified by the receiver, sender, or both during earlier interactions. In some ways, this system may provide a “double-blind” system in which neither the transferor nor the transferee will need know each other's identity or confidential information.

The process may be driven by a transferee. A transferee may contact the system to indicate that money is to be transferred. The transferee may specify the amount of money to transfer (e.g., may be the only party indicating a specific sum to be added to a beneficiary of the transfer). Other techniques for specifying the amount of the transfer may also be implemented. For example, the transferor may be given an opportunity to confirm an amount that is specified by the transferee.

In a telephone-based implementation, a receiver, one who will be receiving funds, may call a host computer using a communications channel such as public telephone network. The host computer may next identify the receiver using caller identification, and may retrieve receiver card information from a card number database. The host computer may then prompt the receiver regarding a transfer. For example, the receiver may be prompted to send money, receive money, or check account balance. If desired, if the receiver selects to receive money, the receiver may be prompted to input the amount to receive. The host computer may next prompt the receiver for their personal identification number (PIN). Next, the receiver may input their PIN, and the host computer may transmit a balance inquiry to receive through an automated teller machine (ATM)/debit network. If the account of the receiver is not valid or is not in good standing, the receiver may be advised by the host computer and the process may be aborted. Otherwise, the host computer may send a transaction code to the receiver.

Next, the host computer or other provider (e.g., the receiver) may send the transaction code to the sender using, for example, a different communications channel from that used to communicate with the receiver. The host computer may store the transaction code and the amount of the transaction (if entered) in a central database.

The sender may next call the host computer, which if desired, may identify the sender using caller identification. If, for example, the caller identification of the sender is valid, the host computer may retrieve sender card information from a card number database, and may prompt the sender to transfer money such as to prompt to select to either send money, receive money, or check their account balance.

If the sender elects to send money, the host computer may prompt the sender to enter the transaction code. Next, the sender may input the transaction code to the host computer, which the host computer may check against the central database and may retrieve the transaction amount (if known). The host computer may advise the sender of the transaction amount and may query the sender as to whether transfer should continue. If desired, the host computer may prompt the sender for a transfer amount. The amount of the transfer may be entirely controlled by the transferor. If the sender selects to not continue the transfer, the process may be aborted. Otherwise, the host computer may prompt the sender for their PIN.

If desired, after the sender inputs their PIN, the host computer may check the existence and good standing of the sender's account through the ATM/debit network. If the sender's account is not valid or is not in good standing, the process may be aborted. Otherwise, the host computer may debit the sender's account for the transaction amount through the ATM/debit network, credit the receiver's account for the transaction amount through the ATM/debit network, and if desired, may dial the receiver to notify them of the receipt of payment corresponding to the transaction code.

A user may also the check the balance of their ATM or debit card account. First, the user may call into a host computer, which identifies the user using caller identification. Next, the host computer may retrieve the user's ATM or debit card number from a card number database. Then, the host computer may prompt the user to send money, receive money, or check account balance. If the user selects to check their account balance, the host computer may prompt the user for their PIN. The user then inputs their PIN, at which time the host computer transmits a balance inquiry through an ATM/debit network. Next, the host computer may receive a response from the ATM/debit network, including the account balance, and the host computer advises the user of the account balance.

As mentioned herein, communications platforms or protocols other than telephone communications may also be used in transferring funds.

It is understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

Further features of the invention, its nature and various advantages will be more apparent from the following detailed description, taken in conjunction with the accompanying drawings in which like reference characters refer to like parts throughout, and in which:

FIG. 1 is a flow chart of illustrative steps involved in transferring funds between accounts in accordance with one embodiment of the present invention;

FIG. 2 is a flow chart of illustrative steps involved in transferring funds based on identifying communications addresses of participating parties in accordance with one embodiment of the present invention;

FIG. 3 is a functional block diagram of a fund transfer system and related devices in accordance with one embodiment of the present invention;

FIG. 4 is a schematic diagram of a telephone transfer system in accordance with one embodiment of the present invention;

FIG. 5 is a schematic diagram of the telephone transfer system in accordance with another embodiment of the present invention;

FIGS. 6-8 are flowcharts depicting the process of receiving a payment in accordance with an embodiment of the present invention;

FIGS. 9-12 are flowcharts depicting the process of sending a payment in accordance with an embodiment of the present invention; and

FIG. 13 is a flowchart of a representative process of a user checking their balance in accordance with an embodiment of the present invention.

### DESCRIPTION OF PREFERRED EMBODIMENTS

Transfer of funds between accounts may be executed using a transfer system. The system may permit accountholders to participate in money transfers anonymously. Money may be transferred in real time between accounts upon the use of an electronic key or transfer code. The transfer system may include equipment that interacts with users through a communications medium such as a telephone network and may include equipment for interacting with financial institutions via a financial communications network such as the network used for automated teller machines.

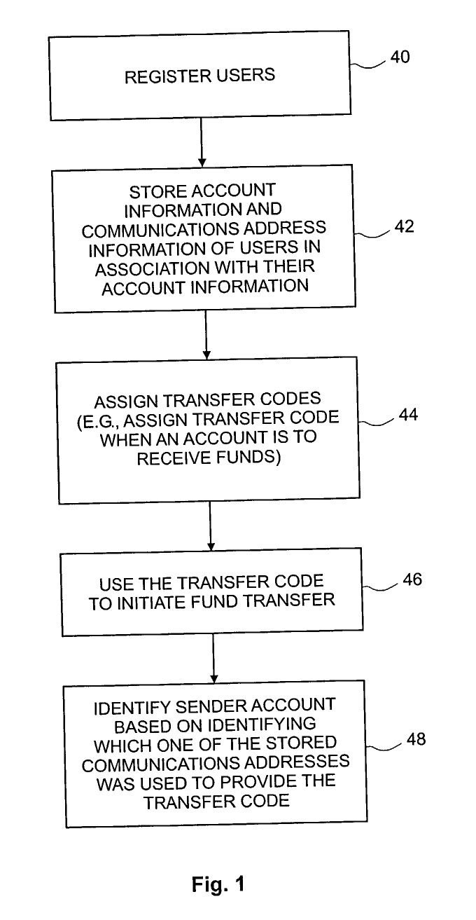

The transfer system may be an electronic interface or intermediary and if desired, may include a database of information and may have capabilities for identifying current users. With reference now to FIG. 1, at step 40, users may be registered to permit access to the transfer system. If desired, users may not be required to register in order to be allowed to use the system. The transfer system may include hardware and/or software for carrying out registration or if desired, other equipment or resources may be used to provide registration. Information may be collected during registration. Information may include account information (e.g., bank accounts), communications addresses used by the users (e.g., addresses linked to that user such as their home telephone number), a desired personal identification code (e.g., a personal identification number), and other information if desired. If desired, collection of information regarding the name or identity of users may intentionally be omitted to allow for anonymity.

At step 42, information that is collected from may be stored for future access. Information may be stored to provide association between information provided for a particular account. Thus, the association between accounts and the communications addresses may be stored in a database for future use. If personal identification codes are being used, the proper association of the codes may also be reflected in the database.

At step 44, transfer codes or keys may be assigned. A transfer code may be assigned when the transfer system receives information indicating that an account (e.g., a registered account) is to receive funds such as cash using the transfer system. The transfer system may receive information indicating that an account is to receive funds. An indication may provided in a number of different ways.

At step 46, the transfer code may be used to initiate a fund transfer. Once assigned, the transfer code may be provided to a desired transferor. The transferor may be given the transfer code to initiate a transfer between a transferor account (e.g., an account that the transferor has registered) and a receiving account. The transferor may initiate the transfer of money by submitting the transfer code to the transfer system via a communications medium. At step 48, the transfer system may identify which registered account is to be used for sending the funds based on identifying the communications address that was used to submit the transfer code to the transfer system. The database may include a list of communications addresses that have been stored through the registration process and the accounts that are associated with those addresses. Once a registered communications address is identified, the account for sending funds is also identified through its association with the address. Other techniques for identifying the transferor account may also be implemented. The account for receiving the funds may be identified through the transfer code which may have been stored in association with information on the receiving account.

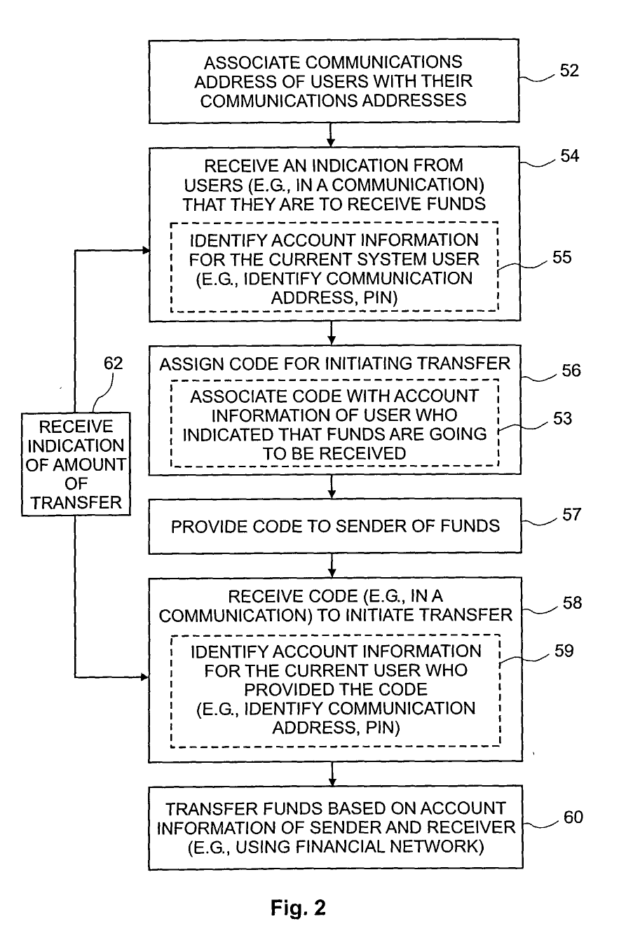

Commencement of the transfer process may be controlled by a transferee. With reference now to FIG. 2, at step 52, communications addresses of system users (e.g., individuals who have financial accounts such as bank accounts with third parties) may be associated with information identifying their financial accounts. More than one communications address (e.g., telephone number) may be associated with a registered account. System users may for example be accountholders of financial accounts. Communications addresses (e.g., an e-mail address, a home telephone number, a pager telephone number, an instant messaging identification, etc.) that are associated with a financial account may be addresses that are owned or associated with an accountholder for establishing communications with that accountholder. Associations may be used for future use (e.g., by retrieving association information from storage). If desired, in some embodiments, transfers are completed without associating communications addresses with financial accounts by for example, having a transferor, a transferee, or both enter account information for a financial account when indicating a desire to receive or send money. If desired, a personal identification code may be set for use in authenticating users. Registration of users as in step 40 of FIG. 1 may be preliminary to step 52. If desired, in some embodiments, money transfers may be performed without registering a transferor, a transferee, or both. One advantage of registration is that it streamlines steps involved in making multiple transfers.

At step 54, an indication may be received from one of the users (e.g., in a communication) that their account is to receive funds. The indication may commence the transfer process. The indication may be given via a prompt in a telephone communication, via a message in a pager communication, via text messaging, via Internet communications, via a dedicated graphical user interface, or via another application or device which permits the current user to indicate that the user is to receive funds.

Step 54 may include step 55 in which account information (e.g., a financial account) of a current system user may be identified. Account information is identified in order to determine the account which is to receive funds. Account information may be identified through various techniques. For example, the transfer system may identify the current communications address (e.g., the telephone number) of a user for use in identifying account information.

If a registration process was used, the transfer system may check to determine whether the current communications address is one that was registered. If the current communications address is a registered address, the account to be used for receiving the funds may be identified through the association of account information with associated communications addresses (see step 52). A user may only register communications addresses that are under his or her control to prevent unauthorized use of their financial account. Authority of a current user may be further verified through the use of a personal identification code.

At step 56, a code may be assigned for initiating a transfer by a sender. The code may be assigned in response to step 54 in which a user indicates that money is to be transferred. The code may be an alphanumeric code or some other coding scheme may also be used. For example, numbers may be generated sequentially for the code. The code may be linked at step 53 by the transfer system to the account information for the financial account that is to receive funds. For example, the financial account of the user who indicated that he or she is to receive funds at step 54. This linking or association provides for quick identification of account information when the transfer code is used. Also, it avoids the need to know personal or confidential information of system users. Step 53 may be implemented as part of step 56.

At step 57, the code may be provided to a person who is to send the funds for the transfer. If desired, the person, who is to send the funds, may already have an account registered with the transfer system or may register once he or she has received the code. If desired, at step 52, a financial account of the person who is to send the funds may be associated with one more communications addresses. In some embodiments, the person, who is to send the funds may be permitted to enter his or her financial account information to be used in the transfer when the system receives a transfer code from that person. The code may be provided to the transferor in various ways. For example, the code may be given to the transferor in person, via e-mail, via a publication, via a text message, etc. The transferee may determine who will be given the code (e.g., the transferee may send the code in an e-mail message to the intended transferor). The transfer system may include equipment that a transferee may use to provide the code to a communications address of an intended transferor.

At step 58, the transfer system may receive the code that was provided to the intended transferor at step 56 in order to initiate the transfer of funds from the transferor's account. At step 59, which may be a part of step 58, the transfer system may identify the financial account for the current user who submitted the transfer code. The account may be identified by determining whether the communications address of the current user is one for which the system has an associated financial account. As mentioned above, if desired, the account may be specified by the user through user entry of account information when the user indicates a desire to transfer funds (e.g., when the user enters a transfer code). If desired, a personal identification code may be entered by the user to further verify the authority of the current user.

The amount of the transfer may be indicated by the transferor, transferee, or both at step 62. At step 62, an opportunity to confirm the amount of the transfer may also be provided (e.g., transferor confirms amount identified by transferee). In some embodiments, the amount of the money to be transferred between accounts is specified into the system only by the transferor. These embodiments may include transfer processes where the money transfer process was commenced by a transferee. The sum that is specified may be used to indicate a total sum of cash funds that is to be withdrawn and equally deposited into an intended transferee or intended beneficiary financial account. Thus, credit card transactions in which a fee for the transaction is collected as a percentage of a sum of a payment may not be included in such transfers. In addition, in some embodiments, these techniques help to alleviate existing deficiencies in techniques for transferring cash from one account to another (e.g., one consumer bank accountholder in one bank seeking to send money to another consumer bank accountholder in another bank). One example of this is when two family members seek to transfer money between their accounts.

At step 60, the desired transfer may be performed based on account information of the transferor and the transferee. The transfer system may interact with a financial network such as a network used for supporting automated teller machines to perform the transfer. Thus, in some embodiments, the transfer system may include a communications interface for communicating with an automated teller machine network to perform a transfer between accounts of financial institutions that are on the network. The financial network may be a network that is dedicated primarily to performing financial activity (e.g., securely performing financial activity). An advantage of such communications capability is the quickness at which cash can be debited from one account and credited to another account without the need for paper money or other procedural steps.

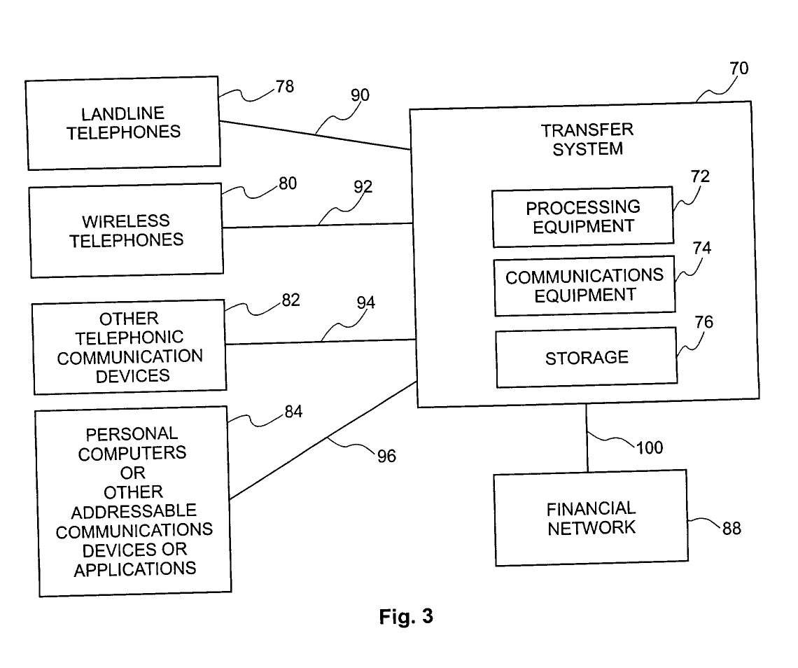

Transfers may be conducted using a variety of platforms. With reference now to FIG. 3, transfer system 70, which may be used to implement the systems and methods illustratively described herein, may communicate with financial network 88 and may communicate with different types of communications devices such as landline telephones 78, wireless telephones 80, other telecommunications devices 82 (e.g., pagers, personal digital assistants, etc.), or personal computers or other addressable communications devices or applications 84.

Transfer system 70 may include processing equipment 72, communications equipment 74, and storage 76. If desired, communications equipment 74 and/or storage 76 may be considered to be part of processing equipment 72. Processing equipment 72, communications equipment 76, and storage 76 may include sufficient hardware, software, or combinations thereof to implement the techniques illustratively described herein. Processing equipment 72 may include processors, RAM, ROM, an arithmetic logic unit, a personal computer, a network of computers, a server, a mainframe computer, a workstation, or other processing or processor related equipment. Communications equipment 74 may include software and/or hardware to support communications with financial network 88 and to support communications with one or more of the different types of user devices, such as landline telephones 78, wireless telephones 80, other telephonic communications devices 82, personal computers or other network addressable communications devices or applications 84. Communications equipment 74 may include circuitry or devices for supporting such communications such as an Internet protocol interface, a telecommunications switch, a computer network interface card, etc. Each of the different types of user device may have a network communications address (e.g., a telephone number, an e-mail address, an instant messaging address, an SMS messaging address, etc.). Communications equipment may also include detection software and/or hardware for identifying the communications address from which a user communicates with transfer system 70. Communications equipment 74 may provide two-way communications.

Storage 76 may store a database of information that is collected during the registration process (or other data collection activity) and may store information regarding the transfer codes and the amount of transfers.

Landline telephones 78 may be telephones on a public switch telephone network (PSTN) which may communicate with transfer system 70 via link 90 which may include a PSTN. Conventional caller identification techniques may be used to identify telephone addresses. Wireless telephones 80 may be cellular telephones that communicate with transfer system 70 via link 92 which may include a PSTN, a wireless communications network, or a private network, etc. Conventional caller identification techniques for identifying wireless callers may be employed. Personal computers 84 may communicate with transfer system 70 via link 96 which may include a computer communication network such as the Internet or other communications networks. Communications between personal computer 84 and transfer system 70 may be e-mail communications, instant messaging communications, or other addressable communications supported by personal computers. Other telephonic communications devices 82 may include pagers or other devices and may use link 94 which may include communication pathways such as those illustratively mentioned above for landline telephone 78 and wireless telephones 80.

Link 100 may be a link for communications with financial network 88, which for example may carry communications for communications with an ATM communications network. Financial network 88 may be an ATM network and may include communications links with financial institutions at which users have accounts.

If desired, one or more of landline telephones 78, wireless telephones 80, other telecommunications devices 82, or personal computers (or other network addressable communications devices or applications) 84 may be used to register users, to collect information on users, to indicate that an account is to receive funds, to provide a transfer code to users, to receive a transfer code from users, to receive confirmation of transfers, and other related activity. In some instances herein, transfer system 70 may be discussed in the in context of transfer system 70 include user interface devices, their supporting communications links, financial network 88, and/or its supporting communications link.

Users may communicate with transfer system 70 via key entry or text entry using their user interface device. If desired, transfer system 70 may be equipped with voice analysis equipment to communicate with users via voice communications. If desired, human operators may be used by the transfer system for handling user interactions and transfer activity.

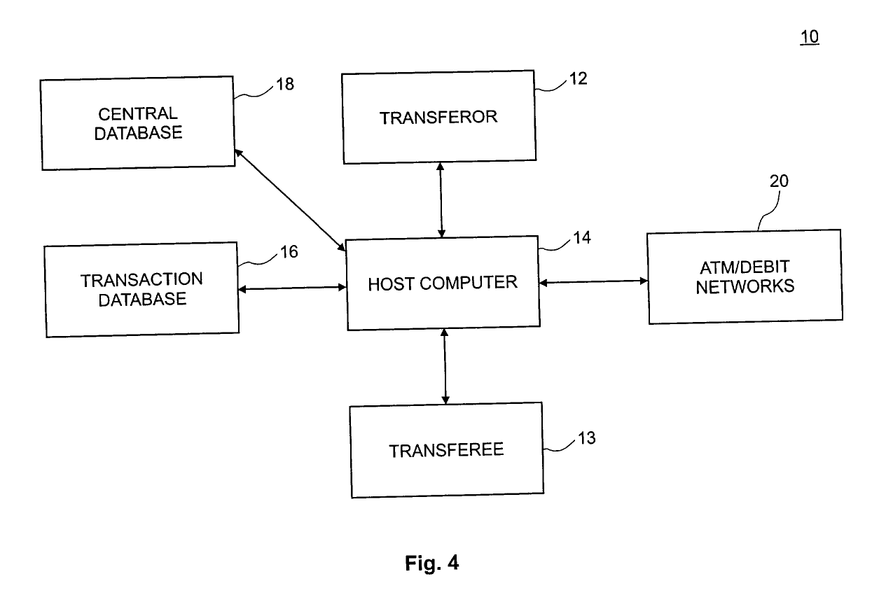

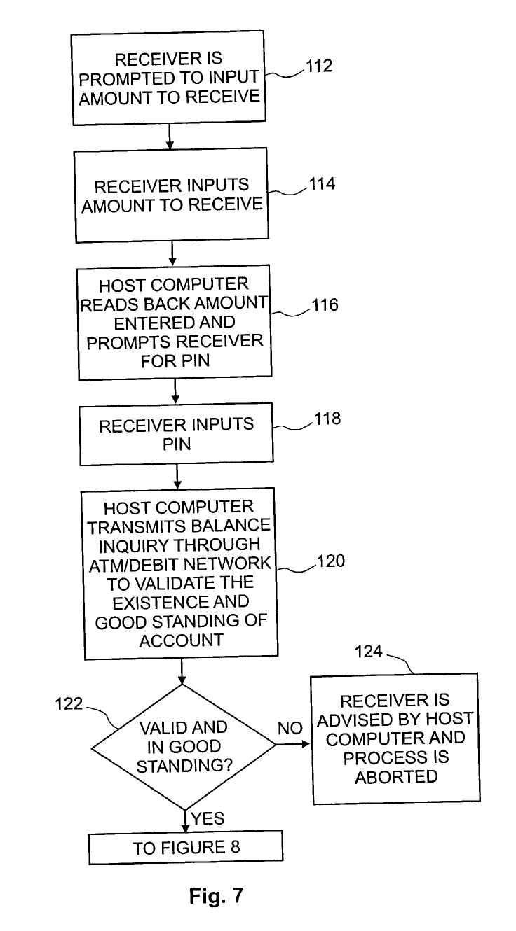

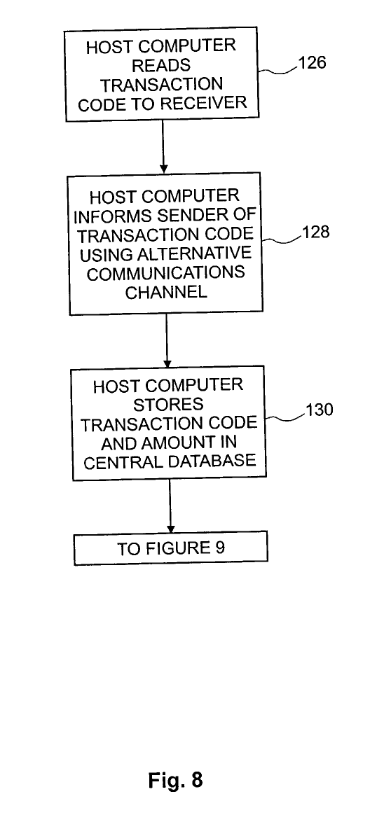

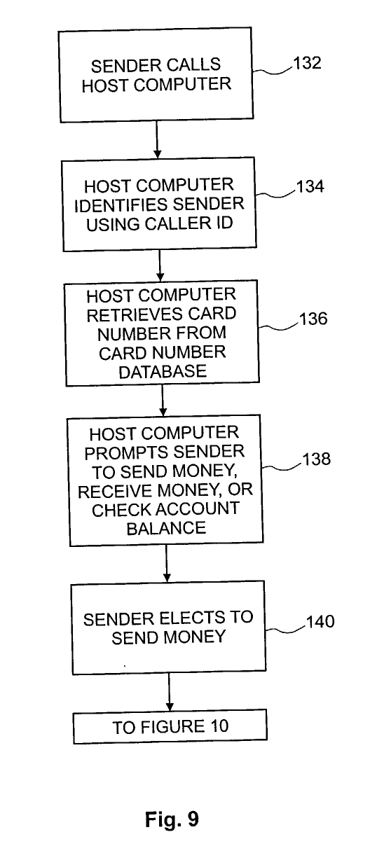

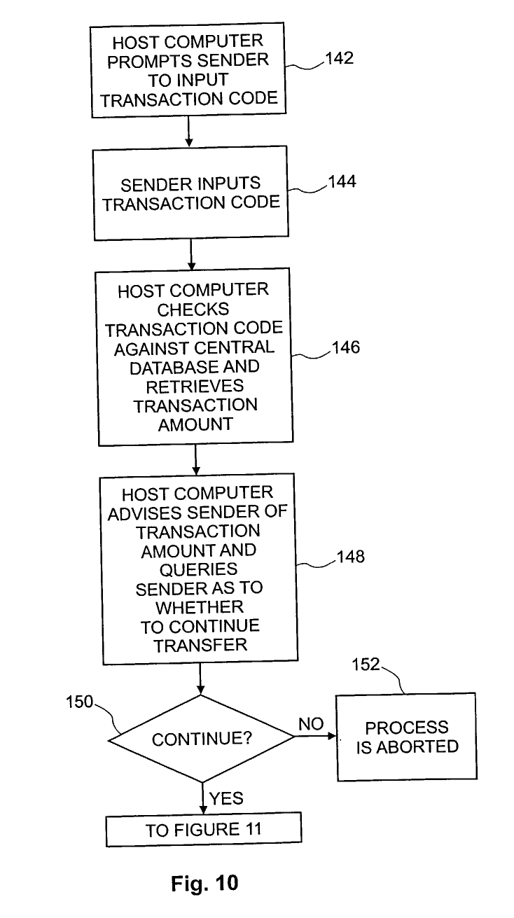

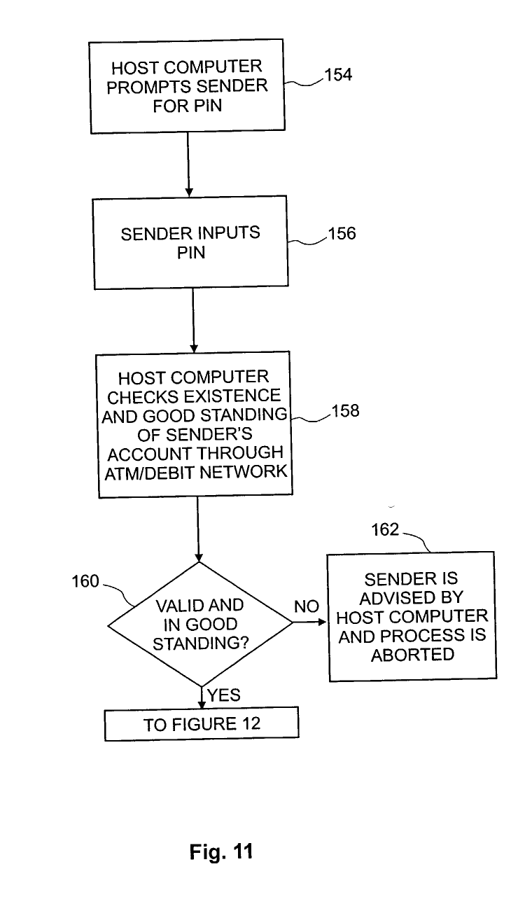

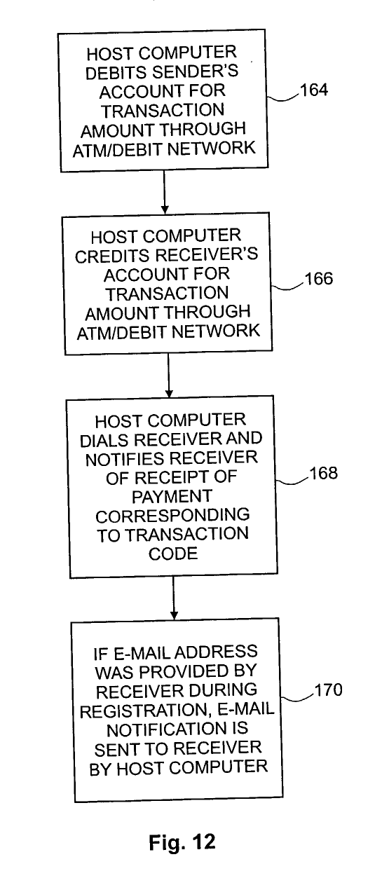

One embodiment of a telephone-based implementation of the systems and methods illustratively described in connection with FIGS. 1-3 is illustratively described in connection with FIGS. 4-13. Variations from this implementation such as not requiring user registration are mentioned above. Referring to FIG. 4, telephone transfer system 10 may include a plurality of transferors 12 and transferees 13 which have access to a telephone (landline or cellular); at least one host computer 14 which is configured to receive telephone calls from registered system users and identify the telephone numbers of the user; database 16 accessible to host computer 14 which correlates user telephone numbers with account information of a user such as a user's ATM or debit card number or an account number of the user; central database 18 may be accessible to host computer 14 having transaction codes with corresponding amounts stored therein; and a connection to existing ATM/Debit network infrastructure 20.

To given access to the system, a user may register with the entity that will be operating the system. The details of the registration process may depend on the particular entity. Some examples of information that may be requested are provided above. In most cases, each user will provide a telephone numbers and card number for use in connection with their financial account. This information may be stored in the user database for future reference.

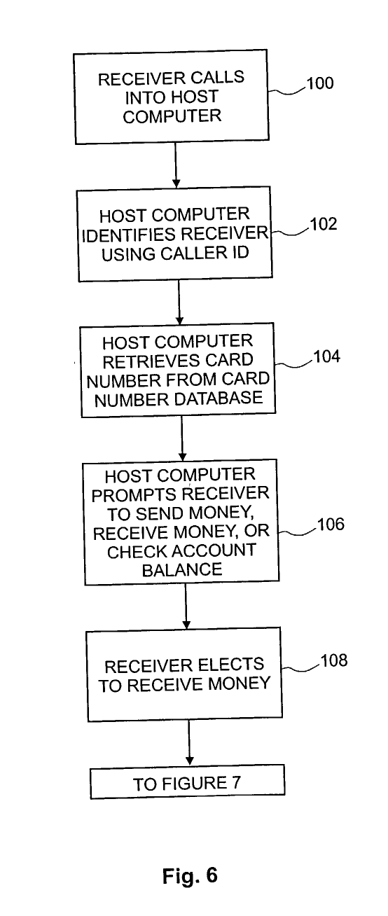

FIG. 6 illustrates that the transfer system may include a network of computers 14 for processing transfers which may have access transaction database 16. Users 21 may interact with different host computers 21 which will still have access to information in database 16 and may carry out the transfer through communications with ATM/debit networks 20.

For the purposes of the following description, which describes the transfer of money from a sender to a receiver, it is assumed that the sender and receiver have both completed the registration process.

With reference now to FIGS. 6-12, at step 100, a receiver, a user who is to receive funds, may initially place a telephone call to the host computer. At step 102, using standard caller ID technology, the host computer may identify the receiver and at step 104, may retrieve the receiver's card number from the user database. At step 106, the host computer may prompt the user to receive money. At step 106, the host computer may also present other prompts such as to send money or check the balance on the receiver account. If the user selects the balance check option, the host computer may determine the balance via the ATM/Debit network infrastructure and return the balance to the user.

At step 108, the user may elect to receive funds. In some embodiments, the receiver may elect to receive funds by pressing an appropriate button on his telephone in response to the prompt. Upon election, at step 114, the receiver may enter the amount he/she would like to receive, e.g., by using the telephone keypad. If desired, the receiver may be prompted to enter the amount information. Upon entry of the amount, at step 116, the host computer may read back the amount to the receiver and ask the user to enter his/her PIN (personal identification number). At step 118, the receiver may enter his/her PIN for example, using the telephone keypad. At step 120, the host computer may send a balance inquiry through the ATM/debit network to validate the existence and good standing of the account for receipt. At step 122, the host computer identified whether the account does not exist or is not in good standing. At step 124, the host computer may notify the receiver that the account does not exist or is not in good standing and abort the process in response to step 122.

If the account exists and is in good standing, the host computer may generate a transaction code. At step 126, the transaction code may be given to the receiver.

If desired, at step 126, the transaction code may be given to the receiver through another means of communication (telephone, e-mail, etc.). At step 128, the sender may also be informed of the transaction code using alternative communications medium. At step 130, the code may be stored in the transaction database. At step 132, to complete the transfer, the sender, the user who will be sending funds, may telephone the host computer. At step 134, the host computer, which may be part of transfer system 70 of FIG. 3, may identify the sender using caller identification. At step 136, the host computer may retrieve a card number for the sender from the card number database. At step 138, the sender may be prompted to send money, receive money, or to check account balance. At step 140, the sender may elect to send money in response to the prompt. At step 142, the sender may be prompted for a transaction code by the computer and at step 144, may enter the transaction code using for example, a telephone keypad. At step 146, upon entry of the code, the computer identifies the transaction amount based on the transaction code. At step 148, the sender may be informed of the amount of the transaction and if desired, may be prompted as to whether to continue. At step 150, the computer may determine whether the sender has elected to continue. At step 152, the process may be aborted when the sender elects not to continue. At step 154, the host computer may request that the sender enter his PIN. Upon entry of the PIN at step 156, the host computer may use the ATM/Debit network infrastructure to verify the sender's account information and verify that there are sufficient funds to complete the transaction. At step 160, the host computer may determine whether the account is valid and in good standing. At step 162, if the account information is incorrect (e.g., the PIN is incorrect or the card number is incorrect or invalid) or if there are insufficient funds to cover the transaction, the process is aborted.

If, on the other hand, the account information is correct and there are sufficient funds to cover the transaction, then the host computer may debit the sender's account at step 164 and credit the receiver's account at step 166 using the ATM/Debit network infrastructure.

If desired, in response, at step 168, the host computer may dial the receiver of the funds and may notify the receiver of the receipt of payment for the amount registered to the particular transaction code. If desired, at step 70, the host computer may send an e-mail notification of the transfer to the receiver if the receiver provided an e-mail address during registration.

Those of ordinary skill in the art will appreciate the versatility of the techniques illustratively described herein. For example, a receiver can establish a permanent code if desired. Thus, a taxi driver or other service provider could obtain a permanent code and put the code on a sign in the cab. Passengers may then use the system to pay the cab fares. When using a permanent code, however, the system may have to be configured to allow the sender to enter the amount since the amount will change from transaction to transaction.

In addition, those of ordinary skill in the art will appreciate that in some embodiment, since the transaction code is initiated by the desired receiver of the funds, the sender is only able to transfer to an appropriate account and will not be permitted to send money to another account.

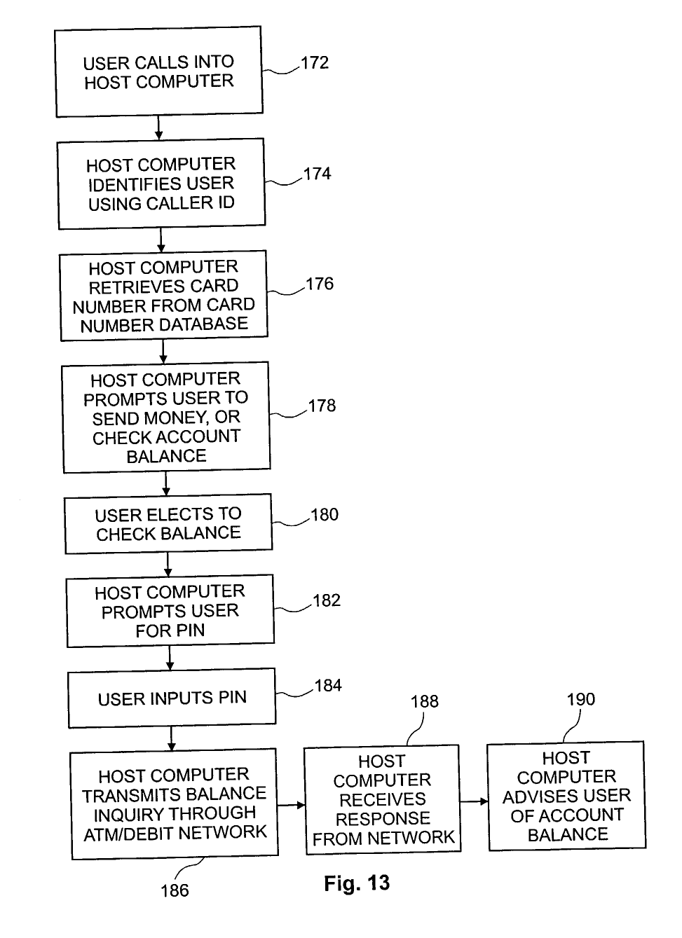

A check balance feature may also be provided. With reference to FIG. 13, at step 172, a user may call into a host computer. At step 174, the host computer may identify the caller using caller identification. At step 176, the host computer may retrieve card number or account number information from an information database. At step 178, the host computer may prompt the user to send money, receive money, or to check account balance. At step 180, the user may elect to check balance. At step 182, the host computer may prompt the user for a PIN. At step 184, the user may enter a PIN. At step 186, the host computer may transmit balance inquiry through ATM/debit network. At step 188, the host computer may receive a response regarding the inquiry. At step 190, the host computer may advise the user of the account balance.

Those of ordinary skill in the art will appreciate that, although the techniques herein are primarily discussed in the context of telephone communication and caller ID, other methods of communication can also be employed wherein the communication endpoint is identified and an associated account is identified, and through that communication method the user may enter a PIN and receives a transaction code (examples of other communications methods are also provided herein).

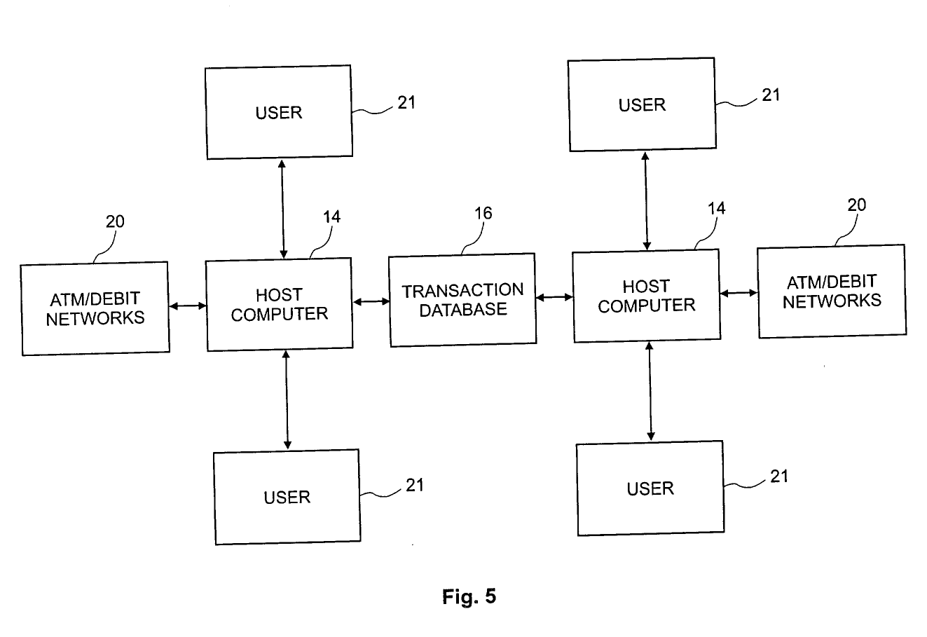

Additionally, the present invention is not limited to a single host computer. Rather, multiple host computers linked to the central transaction database may be used (see FIG. 5). This provides the system with great versatility and enables multiple endpoints to the transfer system to be located near customers with different entry methods and/or languages.

If desired, in some embodiments, the transfer system interacts with transferor's and transferee's only through telephone communications (e.g., communications not including email, instant messaging, or other computer network communications techniques). If desired, in some embodiments, transfers are accomplished through communications with an automated teller machine communications networks (e.g., accomplished only through communications with an automated teller machine communications network). If desired, in some embodiments, registration is not required by any of the transfer system users by allowing users to perform instant transfers by specifically entering account information for each transfer.

Computer readable medium may store in computer executable form processes, services, or features illustratively described herein for implementation on one or more host computers to provide such processes, services, or features to individuals or companies who seek to conduct transfers.

Thus, in accordance with the foregoing the objects of the present invention are achieved. Modifications to the foregoing would be obvious to those of ordinary skill in the art, but would not bring the invention so modified beyond the scope of the appended claims.

What is claimed is:

1. A method for automatically transferring a desired sum of money from one financial account to another, comprising:
associating a communications address with each of a plurality of financial accounts for communicating with corresponding accountholders of the financial accounts;
assigning a transfer code in response to a communication indicating that a money transfer is to occur;
utilizing the transfer code to send a specified sum of money from a transferor financial account; and
identifying which one of the pluarlity of the financial accounts is to receive that specified sum of money, based on identifying from which one of the communications addresses the communication was received.

2. The method of claim 1 further comprising transferring money between the identified financial account and the transferor financial account.

3. The method of claim 2 wherein the transferring comprises using a debit communications network to transfer money.

4. The method of claim 3 wherein the using comprising using a communications network that is primarily dedicated for transacting financial activity with financial institutions that are on the network.

5. The method of claim 3 wherein the using comprises using an automated teller machine network to transfer money.

6. The method of claim 1 wherein the associating comprises associating telephone numbers with the financial accounts for communicating with corresponding accountholders of the financial accounts.

7. The method of claim 1 wherein the associating comprises associating network addresses with the financial accounts for communicating with corresponding accountholders of the financial accounts.

8. The method of claim 1 further comprising receiving an indication in the communication that money is to be received.

9. The method of claim 1 further comprising requiring users seeking to take part in transfers to enter a personal identification code.

10. The method of claim 1 further comprising automatically debiting the transferor financial account and crediting the identified financial account in response to the utilizing.

11. The method of claim 1 further comprising registering the pluarlity of financial accounts.

12. The method of claim 11 wherein the associating comprises associating communications addresses with the registered financial accounts.

13. The method of claim 11 wherein the utilizing comprises utilizing the transfer code to send the specified sum of money from one of the registered financial accounts which is the transferor financial account.

14. The method of claim 1 further comprising receiving information specifying the sum of money to be transferred.

15. The method of claim 1 further comprising receiving the transfer code to indicate that the fund transfer is to commence.

16. The method of claim 1 further comprising permitting a user seeking to transfer funds to specify the sum of money that is to be transferred.

17. The method of claim 17 wherein the sum that is to be transferred is only specified by the user that is seeking to transfer funds.

18. The method of claim 1 further comprising communicating over an automated teller machine communications network to accomplish the transfer of the specified sum of money from the transferor financial account to the identified financial account.

19. The method of claim 1 further comprising receiving the transfer code for utilizing the transfer code to send a specified sum of money from a transferor financial account, and identifying which one of the financial accounts is to be used as the transferor financial account based on receiving the transfer code from one of the communications addresses that are associated with the financial accounts.

20. A system for automatically transferring a desired sum of money from one financial account to another, comprising:
equipment that includes processing equipment, communications equipment and storage, the equipment being configured to associate a communications address with each of a plurality of financial accounts for communicating with corresponding accountholders of the financial accounts, to assign a transfer code in response to a communication indicating that a money transfer is to occur, to utilize the transfer code to send a specified sum of money from a transferor financial account, and to identify which one of the pluarlity of the financial accounts is to receive that specified sum of money based on identifying from which one of the communications addresses the communication is received.

21. The system of claim 20 wherein the equipment is configured to transfer money between the identified financial account and the transferor financial account.

22. The system of claim 21 wherein the equipment is configured to communicate with a debit communications network to transfer money.

23. The system of claim 22 wherein the equipment is configured to communicate with a communications network that is primarily dedicated to transacting financial activity with financial institutions that are on the network.

24. The system of claim 23 wherein the equipment communicates with an automated teller machine network to transfer money.

25. The system of claim 20 wherein the equipment is configured to associate telephone numbers with the financial accounts for communicating with corresponding accountholders of the financial accounts.

26. The system of claim 20 wherein the equipment is configured to associate network addresses with the financial accounts for communicating with corresponding accountholders of the financial accounts.

27. The system of claim 20 wherein the equipment is configured to receive an indication in the communication that money is to be received.

28. The system of claim 20 wherein the equipment is configured to require users seeking to take part in transfers to enter a personal identification code.

29. The system of claim 20 wherein the equipment is configured to automatically debit the transferor financial account and credit the identified financial account in response to the utilization of the transfer code to send the specified sum of money.

30. The system of claim 20 wherein the equipment is configured to register the pluarlity of financial accounts.

31. The system of claim 20 wherein the equipment is configured to associate communications addresses with the registered financial accounts.

32. The system of claim 31 wherein the equipment is configured to utilize the transfer code to send the specified sum of money from one of the registered financial accounts which is the transferor financial account.

33. The system of claim 20 wherein the equipment is configured to receive information specifying the sum of money to be transferred.

34. The system of claim 20 wherein the equipment is configured to receive the transfer code to indicate that the fund transfer is to commence.

35. The system of claim 20 wherein the equipment is configured to permit a user seeking to transfer funds to specify the sum of money that is to be transferred.

36. The system of claim 35 wherein the sum that is to be transferred is only specified by the user that is seeking to transfer funds.

37. The system of claim 20 wherein the equipment is configured to communicate over an automated teller machine communications network to accomplish the transfer of the specified sum of money from the transferor financial account to the identified financial account.

38. The system of claim 20 wherein the equipment is configured to receive the transfer code for utilizing the transfer code to send a specified sum of money from a transferor financial account, and to identify which one of the financial accounts is to be used as the transferor financial account based on receiving the transfer code from one of the communications addresses that are associated with the financial accounts.

39. A method of sending payment from a sender's account to a receiver's account, the method comprising:
the receiver calling a host computer using a communications channel;
the host computer identifying the receiver using caller identification;
the host computer retrieving receiver card information from a card number database; and
the host computer prompting the receiver to select an action from the group consisting of send money, receive money, and check account balance;
such that when the receiver selects receive money, the receiver is prompted to input an amount to receive, the receiver inputs amount to receive, the host computer reads the amount to receive input by the receiver and prompts receiver for a personal identification number (PIN) of the receiver, the receiver inputs the PIN, the host computer transmits a balance inquiry for an account of the receiver through an automated teller machine (ATM)/debit network to determine if the receiver's account is valid and capable of receiving the amount.

40. The method of claim 39 wherein, when the account of the receiver is not valid or is not in good standing, the receiver is advised by the host computer and the process is aborted.

41. The method of claim 39 wherein, when the account of the receiver is valid and in good standing, the host computer sends a transaction code to the receiver.

42. The method of claim 41 wherein the host computer sends the sender the transaction code using a communications channel different from the communications channel with the receiver.

43. The method of claim 42 wherein the host computer stores the transaction code and the amount of the transaction in a central database; and further comprising the sender calls the host computer; the host computer identifies the sender using caller identification; the host computer retrieves sender card information from a card number database; and the host computer prompts the sender to select an action from the group consisting of send money, receive money, and check account balance.

44. A method of sending payment from a sender's account to a receiver's account, the method comprising:
the receiver calling a host computer using a communications channel;
the host computer identifying the receiver using caller identification;
the host computer retrieving receiver card information from a card number database; and
the host computer prompting the receiver to select an action from the group consisting of send money, receive money, and check account balance;
such that when the sender elects to send money, the host computer prompts the sender to enter the transaction code, the sender inputs the transaction code to the host computer, the host computer checks the transaction code against the central database and retrieves the transaction amount, the host computer advises the sender of the transaction amount and queries the sender as to whether transfer should continue.

45. The method of claim 44 wherein, when the sender selects to not continue the transfer, the process is aborted.

46. The method of claim 44 wherein the host computer prompts the sender for a PIN of the sender; the sender inputs the PIN of the sender; and the host computer checks the existence and good standing of the sender's account through the ATM/debit network.

47. The method of claim 44 wherein, when the sender's account is not valid or is not in good standing, the process is aborted.

48. The method of claim 44 wherein the host computer debits the sender's account for the transaction amount through the ATM/debit network; the host computer credits the receiver's account for the transaction amount through the ATM/debit network; and the host computer dials the receiver and notifies the receiver of the receipt of payment corresponding to the transaction code.

49. A method of checking the balance of an ATM or debit card account of a user, the method comprising:
the user calling into a host computer;
the host computer identifying the user using caller identification;
the host computer retrieving the user's ATM or debit card number from a card number database;
the host computer prompting the user to send money, receive money, or check account balance;
the host computer prompting the user for a PIN of the user when the user elects to check account balance;
the user inputting the PIN of the user;
the host computer transmitting a balance inquiry through an ATM/debit network;
the host computer receiving a response from the ATM/debit network, including an account balance; and
the host computer advising the user of the account balance.
